(19) United States
(12) Patent Application Publication
(10) Pub. No.: US 2013/0258248 A1
(43) Pub. Date: Oct. 3, 2013

(54) BACKLIGHT DEVICE, LIQUID CRYSTAL MODULE, AND LIQUID CRYSTAL DISPLAY APPARATUS

(71) Applicant: KABUSHIKI KAISHA TOSHIBA, Tokyo (JP)

(72) Inventors: Hirofumi Sakurai, Kumagaya-shi (JP); Hisayuki Mihara, Kodama-gun (JP)

(73) Assignee: KABUSHIKI KAISHA TOSHIBA, Tokyo (JP)

(21) Appl. No.: 13/787,539

(22) Filed: Mar. 6, 2013

(30) Foreign Application Priority Data
Mar. 30, 2012 (JP) 2012-082861

(51) Int. Cl. G02F 1/1335; F21V 8/00

(52) U.S. Cl. CPC G02F 1/133615; G02B 6/0011
USPC 349/65; 362/621

(57) ABSTRACT

A backlight device includes a light source, and a light guide plate. The light source device includes a board, and a plurality of light emitting elements in a row on the board. The light guide plate includes a first surface configured to abut against the board, and a second surface opposing the board, the light emitting elements in between the board and the second surface.

### CROSS-REFERENCE TO RELATED APPLICATION(S)

The present disclosure claims priority to Japanese Patent Application No. 2012-82861, filed on Mar. 30, 2012, which is incorporated herein by reference in its entirety.

### FIELD

Embodiments described herein relate generally to a backlight device, a liquid crystal module, and a liquid crystal display apparatus.

### BACKGROUND

Recently, by using features such as thinness, lightness, and low power consumption, a flat display apparatus such as a liquid crystal display apparatus is widely used as an image display apparatus such as a television receiver or various computer apparatuses.

For example, a light transmisssive liquid crystal display apparatus includes a liquid crystal panel in which a liquid crystal layer is held between a pair of transparent substrates, and a backlight device that is disposed on a rear surface (a surface opposite to an image display surface) of the liquid crystal panel and that guides light emitted from a light source to the liquid crystal panel.

In order to obtain further thinning and miniaturization of such a liquid crystal display apparatus, a backlight device may be thinned Therefore, a backlight device of the edge-light type (the side-light type) is more often employed than that of the direct type.

A backlight device of the edge-light type includes a linear light source, and a thin-plate-shaped light guide plate such as an acrylic resin having a rear surface on which a scatter pattern is printed. The source light from the linear light source is transmitted through the light guide plate, scattered by the scatter pattern on the rear surface of the light guide plate, and then emitted from the principal surface, which is on the liquid crystal panel side, of the light guide plate.

### BRIEF DESCRIPTION OF THE DRAWINGS

FIG. 1 is an perspective appearance view of a liquid crystal display apparatus according to one embodiment;

FIG. 2 is a section view of the liquid crystal display apparatus according to the one embodiment;

FIG. 3 is a perspective appearance view of a liquid crystal module according to the one embodiment;

FIG. 4 is a perspective view schematically showing the configuration of the liquid crystal module according to the one embodiment;

FIG. 5A is a section view of the backlight device according to the one embodiment, taken along a line VA-VA in FIG. 5B;

FIG. 5B is a section view of the backlight device according to the one embodiment, taken along the line II-II in FIG. 1 (an enlarged view of the backlight device shown in FIG. 2);

FIG. 6 is a perspective appearance view of the light source device;

FIG. 7 is a section view of the backlight device 12 of another example according to the one embodiment; and

FIGS. 8A and 8B are views showing modified example of projecting portions.

### DETAILED DESCRIPTION

According to one embodiment, A backlight device includes a light source, and a light guide plate. The light source device includes a board, and a plurality of light emitting elements in a row on the board. The light guide plate includes a first surface configured to abut against the board, and a second surface opposing the board, the light emitting elements in between the board and the second surface.

Various Embodiments will be described hereinafter with reference to the accompanying drawings.

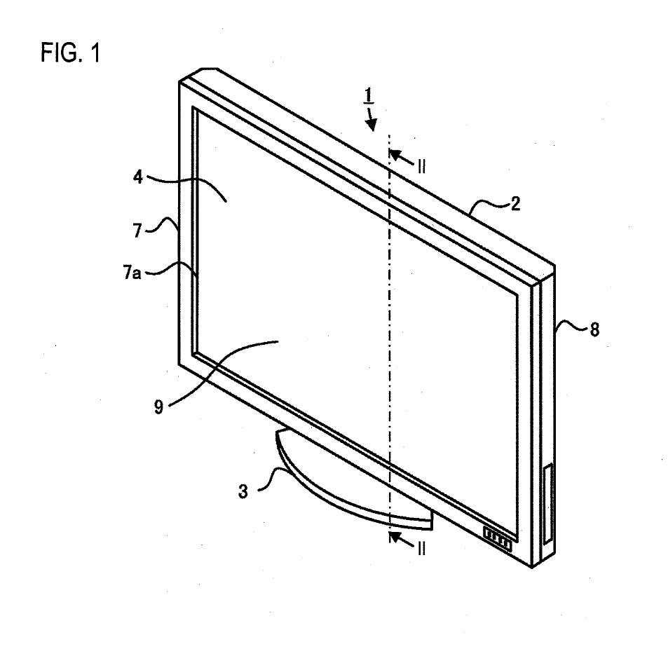

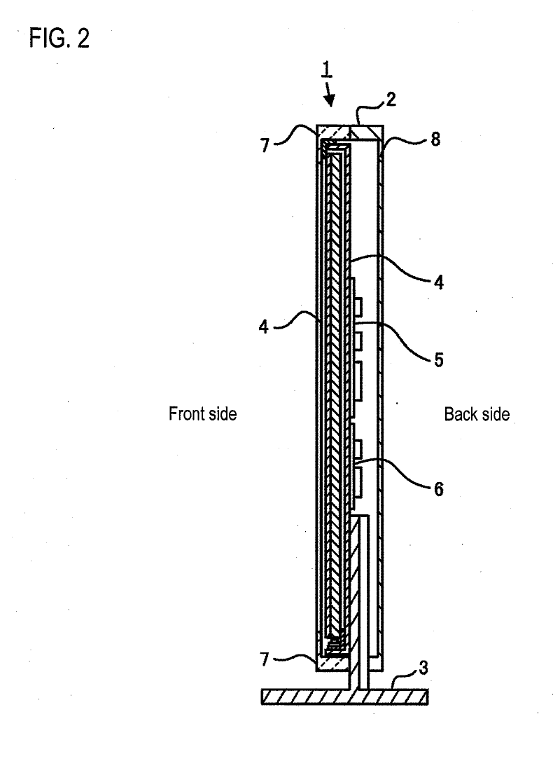

FIG. 1 is a perspective appearance view of a liquid crystal display apparatus 1 according to one embodiment. FIG. 2 is a section view of the liquid crystal display apparatus 1 according to the one embodiment, taken along a line II-II in FIG. 1. The liquid crystal display apparatus 1 includes a casing 2 and a stand 3 that supports the casing 2. A liquid crystal module 4 is provided on a front side of the casing 2. A circuit board 5 that drives the liquid crystal module 4 and a power circuit board 6 are disposed on a back side of the liquid crystal module 4.

An outer surface of the casing 2 is enclosed by a front bezel 7 that partly covers front, upper, lower, and side surfaces of the casing 2, and a back bezel 8 that partly covers back, upper, lower, and side surfaces of the casing 2. A screen 9 is a display portion that is inside a window portion 7a of the front bezel 7 of the liquid crystal module 4.

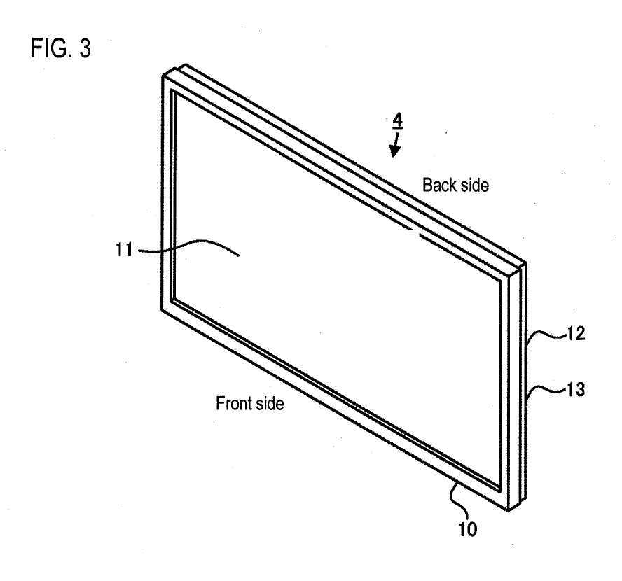

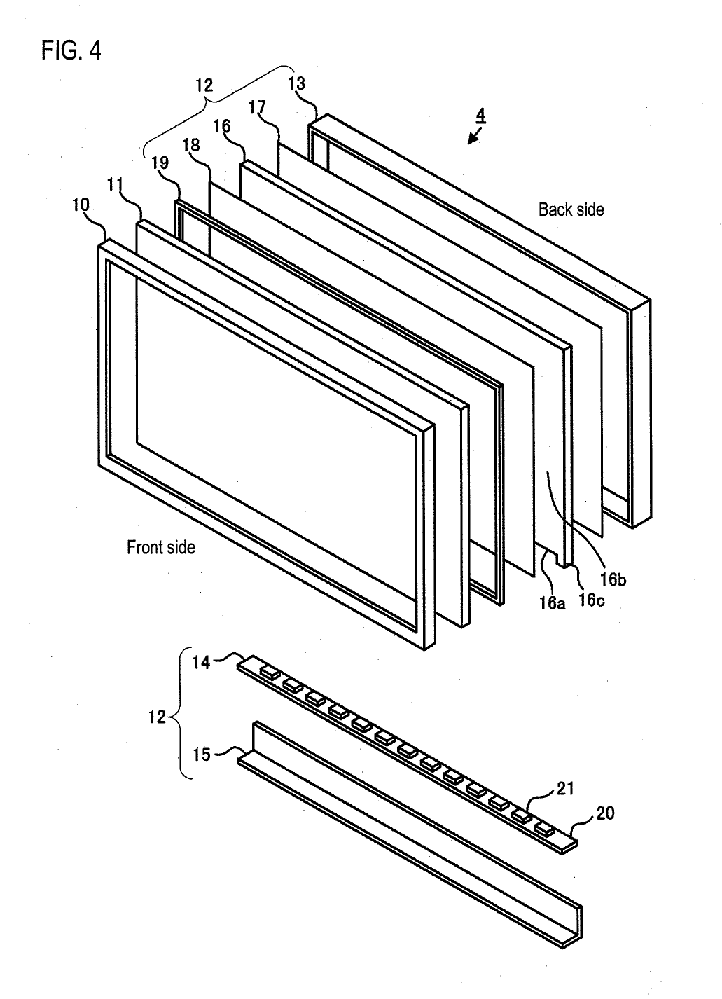

FIG. 3 is a perspective appearance view of the liquid crystal module 4 according to the one embodiment. FIG. 4 is a perspective view schematically showing the configuration of the liquid crystal module 4 according to the one embodiment. The liquid crystal module 4 includes a front cover 10, a liquid crystal cell 11, and a backlight device 12.

The liquid crystal cell 11 is a transmissive liquid crystal panel having a flat plate-like outer shape which is substantially rectangular. The liquid crystal cell 11 has a flat structure in which a gap between at least two substrates (not shown) made of glass or the like is filled with a liquid crystal material. Usually, the gap between the substrates has a size of several micrometers. A polarizing plate (not shown) is disposed on the outside of each substrate.

The backlight device 12 includes a back chassis 13, a light source device 14, a heat radiating plate 15, a light guide plate 16, a reflective sheet 17, an optical sheet (scattering sheet) 18 and an intermediate pressing frame 19. The back chassis 13 is formed by sheet metal working or resin molding. Reinforcing ribs, and screw holes and studs for attaching various components are disposed on the back side of the back chassis 13. The reflective sheet 17, the light guide plate 16, and the optical sheet 18 are disposed on the front side of the back chassis 13, and attached to the back chassis 13 by the intermediate pressing frame 19. The circuit board 5 and the power circuit board 6 are attached to the opposite surface (back side) of the back chassis 13.

The heat radiating plate 15 and the light source device 14 are disposed in a lower portion of the front side of the back chassis 13. The heat radiating plate 15 is processed by extrusion molding or the like, and is made of aluminum or the like. The heat radiating plate 15 has functions of heat radiation of the light source device 14 and positioning of the light source device 14. The heat radiating plate 15 has a substantially L-like shape in section. The light source device 14 is fixed to the upper surface of the bottom side of the L-like shape of the heat radiating plate 15 by adhesion or the like. The heat radiating plate 15 is fixed to the lower portion of the front side of the back chassis 13. Part of heat generated by the light source device 14 is dissipated to the back chassis 13.

The light source device 14 is a circuit board in which a plurality of light emitting elements 21 such as LEDs (Light Emitting Diodes) are mounted in a row on a light emitting element wiring board 20. Examples of the light emitting element wiring board 20 include a rigid board such as a glass epoxy board and an aluminum board, and a flexible wiring board. Each of the light emitting elements 21 is, for example, an LED element having external dimensions of 6 mm in width and 3 mm in length. The plurality of LED elements are mounted on the light emitting element wiring board 20 at intervals of several millimeters to several centimeters. A connector (not shown) through which power for driving the light emitting elements 21 is supplied is provided at an end portion of the light emitting element wiring board 20.

The light guide plate 16 has a plate-like outer shape which is substantially rectangular, and its outer shape is approximately equal in size to that of the liquid crystal cell 11. Examples of the light guide plate 16 include a transparent acrylic plate and a transparent polycarbonate plate. The light guide plate 16 includes a light incident surface 16a on which light emitted from the light source device 14 is to be incident, and a light emitting surface 16b from which the light incident on the light incident surface 16a is to be emitted. The light guide plate 16 is configured so that the light emitted from the light emitting elements 21 is incident on the light incident surface 16a, and then the incident light is repeatedly reflected inside the light guide plate 16, to thereby causing light to be emitted from the entire surface (light emitting surface 16b) which is opposed to the back surface of the liquid crystal cell 11. The light guide plate 16 emits the light supplied from the light source device 14, from the back side of the liquid crystal cell 11.

The reflective sheet 17 is disposed between the light guide plate 16 and the back chassis 13. The reflective sheet is an optical member configured to reflect the light emitted from the light guide plate 16 toward the back chassis 13 to return the light to the light guide plate 16, to thereby use the light efficiently. A reflective material may be applied to the surface, opposite to the reflective sheet 17, of the light guide plate 16.

The optical sheet 18 is disposed on the light emitting surface 16b of the light guide plate 16. The optical sheet 18 is an optical member configured to adjust an emission direction of the light emitted from the light guide plate 16 or to scatter the light, to thereby uniformly illuminate the back surface of the liquid crystal cell 11.

The intermediate pressing frame 19 is a frame-like member which is processed by resin molding, extrusion molding of aluminum, or the like. The intermediate pressing frame 19 has functions of positioning the reflective sheet 17, the light guide plate 16, and the optical sheet 18 on the front side of the back chassis 13, and further positioning the liquid crystal cell 11 with respect to the back chassis 13.

The front cover 10 is a frame-like member which is processed by resin molding, extrusion molding of aluminum, or the like. The front cover 10 is fixed to the backlight device 12 so as to interpose the liquid crystal cell 11 therebetween. The front cover 10 and the back chassis 13 cooperate with each other to form the outer shape of the liquid crystal module 4 and maintain the planar strength of the liquid crystal module 4.

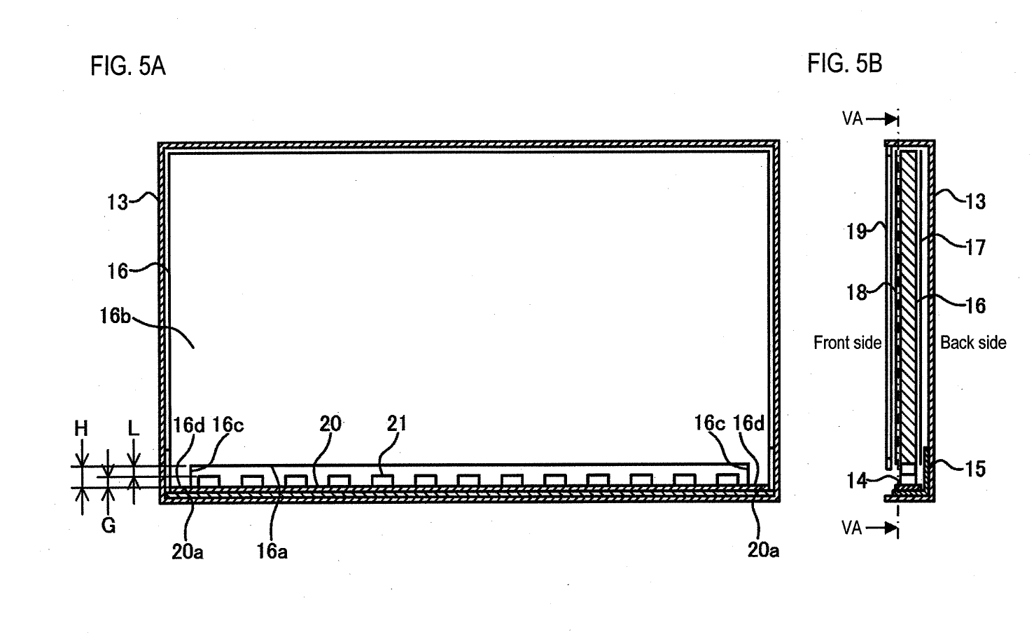

FIGS. 5A and 5B are section views of the backlight device 12 according to the one embodiment. In order to facilitate understanding of the placement relationships of the components, the figures are drawn in a simplified manner. FIG. 5A is a section view of the backlight device 12 according to the one embodiment, taken along a line VA-VA in FIG. 5B and when viewed from the front side of the light guide plate 16 of the backlight device 12. FIG. 5B is a section view of the backlight device 12 according to the one embodiment, taken along the line II-II in FIG. 1. In other words, FIG. 5B is an enlarged view of the backlight device 12 shown in FIG. 2.

The reflective sheet 17, the light guide plate 16, and the optical sheet 18 are disposed on the front side of the back chassis 13 and are disposed so as to be pressed against the back chassis 13 by the intermediate pressing frame 19. The reflective sheet 17, the light guide plate 16, and the optical sheet 18 expand or contract with rise or fall of the temperature, and therefore are slightly movable in the vertical and lateral directions.

The heat radiating plate 15 and the light source device 14 are disposed near a bottom portion of the backlight device 12. The light emitted from the light emitting elements 21 mounted on the light emitting element wiring board 20 is emitted toward the light incident surface 16a of the light guide plate 16.

The light guide plate 16 has first surfaces configured to abut against the light emitting element wiring board 20 and a second surface which is opposed to the light emitting element wiring board 20. The second surface corresponds to, for example, the light incident surface 16a. In this case, the light emitting elements 21 are disposed between the light emitting element wiring board 20 and the second surface. In the light guide plate 16, the light emitted from the light source device 14 is incident on the second surface (light incident surface 16a), and the light is emitted from the light emitting surface 16b to the liquid crystal cell 11.

The first surface configured to abut against the light emitting element wiring board 20 is located at a position closer to the light emitting element wiring board 20 than the second surface toward. Steps between the first surfaces and the second surface form projecting portions 16c in the portions where the first surface is provided. The first surfaces, for example, correspond to surfaces which are located in tip end portions 16d of the projecting portions 16c and which face and abut against the surface 20a of the light emitting element wiring board 20. The projecting portions 16c are disposed near the both end portions of the light guide plate 16, respectively. The tip end portions 16d of the projecting portions 16c near the both end portions abut against the surface 20a of the light emitting element wiring board 20. The projecting portions 16c are formed by integral molding with the light guide plate 16.

In FIG. 5A, a height H of the projecting portions 16c is equal to a distance between the tip end portions 16d and the light incident surface 16a. Therefore, the height H indicates a length of the steps between the first surfaces and the second surface. A distance L is equal to a distance from a surface of each light emitting element 21 to the light incident surface 16a. A height G is a height of the light emitting elements 21. Therefore, the height H is equal to a sum of the height G of the light emitting elements 21 and the distance L. In the case where the light emitting elements are LEDs, for example, the height G of the light emitting elements 21 is in a range of from 0.5 mm to about 2 mm. Usually, the distance L is set in a range of from 0.1 mm to several mm (for example, 10 mm). In a further detailed setting, the distance L may be set in a range of from 0.6 mm to 0.7 mm.

The distance L affects the brightness and brightness distribution of the light emitted from the light emitting surface 16b of the light guide plate 16. The variation of the distance L is affected by that of the height H of the projecting portions 16c. However, the height H of the projecting portions 16c is varied in a small degree. Hence, the variation of the distance L is small. Therefore, it is possible to suppress variation of the brightness and brightness distribution of the light emitted from the light emitting surface 16b. Since the vertically downward directed weight due to the mass of the light guide plate 16 always acts, the tip end portions 16d of the projecting portions 16c can stably keep the state where the tip end portions 16d abut against the surface 20a of the light emitting element wiring board 20.

When the tip end portions 16d of the projecting portions 16c directly abut against the surface 20a of the light emitting element wiring board 20, consideration about the dimension accuracy of interposed components and the dimension variation of the interposed components due to thermal expansion can be eliminated. Therefore, variation of the distance L due to the temperature and deviation of the light guide plate 16 in the lateral direction can be suppressed. For example, assuming arguendo that the light emitting element wiring board 20 is positioned with respect to the heat radiating plate 15 and that the light guide plate 16 is positioned with respect to the heat radiating plate 15. In this comparative example, since the heat radiating plate 15 is interposed, it is required to consider the dimension accuracy of components of the heat radiating plate 15. Since the heat radiating plate 15 is interposed, it is also required to consider dimension variation of the heat radiating plate 15 due to thermal expansion.

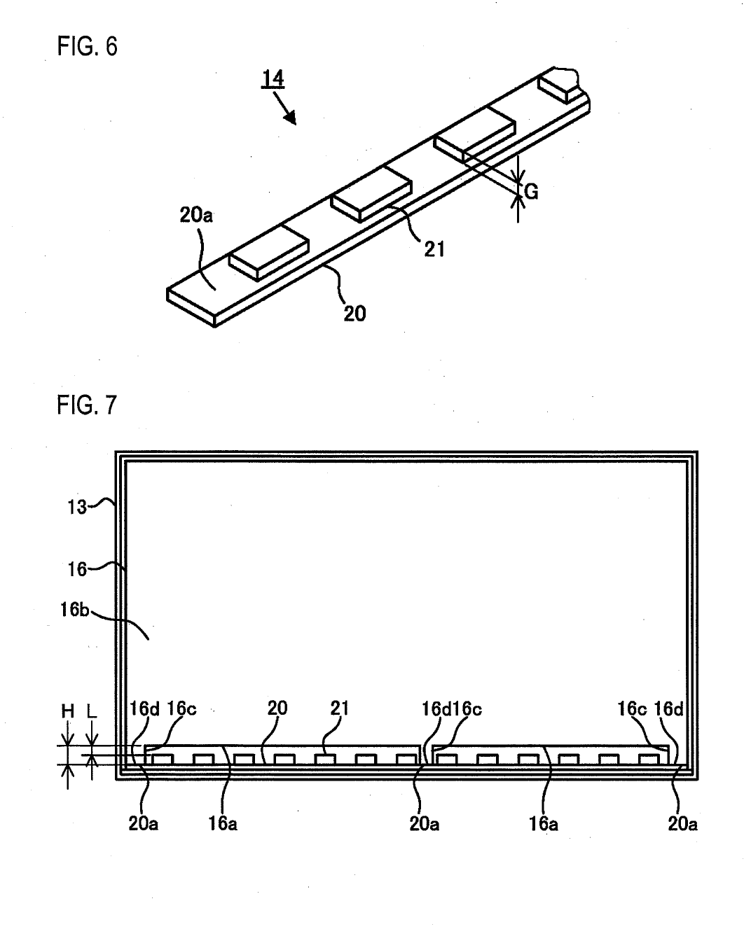

FIG. 6 is a perspective appearance view of the light source device 14. The surface of the light emitting element wiring board 20 on which the light emitting elements 21 are mounted is the surface 20a functioning as a reference surface. In the case where the projecting portions 16c of the light guide plate 16 abut against the surface 20a of the light emitting element wiring board 20, the light emitting element wiring board 20 may be a rigid board such as an aluminum board.

FIG. 7 is a section view of the backlight device 12 of another example according to the one embodiment. FIG. 7 shows an example where projecting portions 16c configured to abut against the surface 20a of the light emitting element wiring board 20 are disposed not only near the both ends of the light guide plate 16, but also near a center between the both ends of the light guide plate 16. In FIG. 7, three projecting portions 16c are disposed. Alternatively, a larger number of projecting portions 16c may be disposed.

As described above, the plurality of projecting portions 16c projecting toward the light emitting element wiring board 20 are disposed not only near the both ends of the side surface where the light incident surface 16a (an example of the second surface) of the light guide plate 16 is provided, but also in an intermediate position between the both ends. The tip end portions 16d (examples of the first surfaces) are configured to abut against the surface 20a of the light emitting element wiring board 20. Therefore, it becomes easy to keep the dimension accuracy of the distance L (the distance between the surfaces of the light emitting elements 21 and the light incident surface 16a). Also, the variation of the distance L due to a temperature change can be suppressed. Consequently, the light emitted by the light emitting elements 21 can be efficiently used, and the optical performance of the backlight such as the brightness and the uniformity of the brightness can be improved.

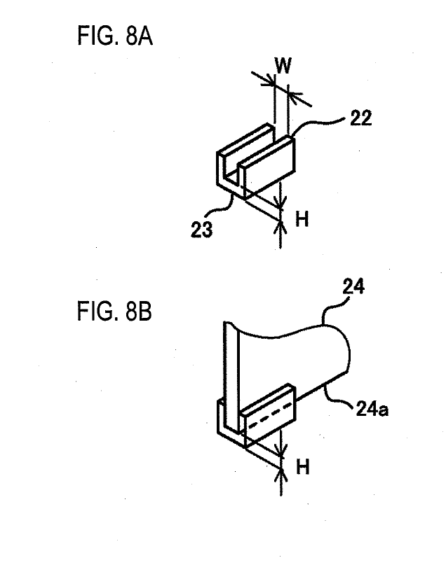

FIGS. 8A and 8B are views showing modified example of projecting portions. As shown in FIG. 8A, a projecting component 22 has a U-like shape in section, and a bottom portion 23 of the projecting component 22 has a thickness of H. An inner width W of the U-like shape is slightly larger than a thickness of a light guide plate 24. A material of the projecting component 22 may be the same as that of the light guide plate 24. However, the material of the projecting component 22 is not limited to this. When the projecting component 22 is fitted on an end portion of the light guide plate 24 in which no integrated projection is formed, a projecting portion having the height H can be provided on the light guide plate 24 as shown in FIG. 8B. Such projecting components 22 may be fixed by adhesion or the like near the both ends of a light incident surface 24a of the light guide plate 24 and/or an intermediate portion between the both ends.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A backlight device comprising:
a light source device comprising
a board, and
a plurality of light emitting elements in a row on the board; and
a light guide plate comprising
a first surface configured to abut against the board, and
a second surface opposing the board, the light emitting elements in between the board and the second surface.

2. The backlight device of claim 1, wherein the first surface is near both end portions of the light guide plate.

3. The backlight device of claim 1, wherein one or more first surfaces are near both end portions of the light guide plate and between the both end portions of the light guide plate.

4. The backlight device of claim 1, wherein a projecting portion including a step between the first surface and the second surface is integrally molded with the light guide plate.

5. The backlight device of claim 1, wherein a step between the first surface and the second surface has a length being in a range from a sum of a height of the light emitting elements and 0.1 mm to the sum of the height of the light emitting elements and 10 mm.

6. The backlight device of claim 1, wherein the light emitting elements are on a front surface side of the board.

7. A liquid crystal module comprising:
a light transmissive liquid crystal cell comprising a plate-like outer shape being substantially rectangular; and
a backlight device comprising
a light source device comprising
a board, and
a plurality of light emitting elements in a row on the board, and
a light guide plate comprising
a first surface configured to abut against the board, and
a second surface opposing the board, the light emitting elements in between the board and the second surface.

8. A liquid crystal display apparatus comprising:
a light transmissive liquid crystal cell comprising a plate-like outer shape being substantially rectangular;
a backlight device comprising
a light source device comprising
a board, and
a plurality of light emitting elements in a row on the board, and
a light guide plate comprising
a first surface configured to abut against the board, and
a second surface opposing the board, the light emitting elements in between the board and the second surface; and
an electric circuit board configured to drive the liquid crystal cell or the light source device.
